(19) United States
(12) Patent Application Publication
(10) Pub. No.: US 2024/0096547 A1
(43) Pub. Date: Mar. 21, 2024

(54) COIL DEVICE

(71) Applicant: TDK CORPORATION, Tokyo (JP)

(72) Inventors: Tomohiro FURUICHI, Tokyo (JP); Masaru KUMAGAI, Tokyo (JP); Takuma TANAKA, Tokyo (JP)

(73) Assignee: TDK CORPORATION, Tokyo (JP)

(21) Appl. No.: 18/465,449

(22) Filed: Sep. 12, 2023

(30) Foreign Application Priority Data
Sep. 15, 2022 (JP) 2022-147105

(51) Int. Cl. H01F 27/32; H01F 27/02; H01F 27/28; H01F 27/29

(52) U.S. Cl. CPC H01F 27/325; H01F 27/02; H01F 27/2828; H01F 27/29

(57) ABSTRACT

The present disclosure provides a coil device that can be reduced in height, has a small installation area of a case, and is excellent in heat dissipation. A coil device according to the present disclosure includes: a device body including a bobbin and a coil unit of a wire wound around the bobbin; a terminal block arranging a lead portion drawn out from a wire of the coil unit thereon; and a case capable of accommodating the device body. The case includes a support arm extending outside the case, and the terminal block is held by the support arm.

### BACKGROUND OF THE INVENTION

### 1. Field of the Invention

The present invention relates to a coil device suitably used as, for example, a transformer.

### 2. Description of the Related Art

As a coil device used for a transformer or the like, for example, a coil device shown in JP 2014-93405 A below has been developed. In this developed coil device, a bobbin around which a wire is wound is accommodated inside a case, and the inside of the case is filled with a resin having excellent heat transfer property such as a potting resin, thereby enhancing heat dissipation.

However, in recent years, it is required to reduce the height of a coil device such as a transformer. Furthermore, it is required to improve heat dissipation property while reducing an installation area of the case.

### CITATION LIST

### Patent Literature

Patent Literature 1: JP 2014-93405 A

### BRIEF SUMMARY OF THE INVENTION

The present invention has been made in view of such circumstances, and an object of the present invention is to provide a coil device that can be reduced in height, has a small installation area of a case, and is excellent in heat dissipation.

In order to achieve the above object, a coil device according to the present invention includes:
a device body including a bobbin and a coil unit of a wire wound around the bobbin;
a terminal block arranging a lead portion drawn out from a wire of the coil unit thereon; and
a case capable of accommodating the device body, in which
the case includes a support arm extending outside the case, and
the terminal block is held by the support arm.

In this coil device, the support arm extending to the outside of the case is provided, and the terminal block is held by the support arm. Therefore, it is not necessary to increase an installation area of the case corresponding to an area of the terminal block, and the installation area of the case can be reduced. Furthermore, since it is not necessary to dispose the terminal block on the case, it is possible to reduce the height of the case, that is, the height of the coil device.

Furthermore, by filling the inside of the case with a heat dissipation resin such as a potting resin, heat from the wire or the bobbin (including a core) can be released to a bottom surface of the case via the heat dissipation resin, and the heat dissipation is improved. Furthermore, since the terminal block is supported by the support arm protruding outward from a side wall of the case, at least most of the bobbin (including the wire and the core) including the winding shaft of the wire can be brought into contact with the heat dissipation resin inside the case without being hindered by the terminal block. Therefore, the heat dissipation can be effectively enhanced by the minimum required heat dissipation resin.

Furthermore, it is possible to form a void space between a surface of a substrate or the like on which the case is installed and the support arm, and it is possible to dispose other circuit substrates and electronic components thereof (for example, capacitors) in the void space, and it is possible to effectively utilize a space on the substrate on which the case is installed.

Preferably, the support arm is formed integrally with the case. Since the support arm formed integrally with an outer wall of the case supports the terminal block, the strength and reliability of the terminal block can be improved. In particular, when a terminal included in the terminal block of the coil device is connected to an external substrate, the support arm reinforces the strength of the terminal block, so that connection with the substrate is facilitated and reliability is improved.

Preferably, the case is made of metal. The case can be made of a resin having excellent heat dissipation, but by being made of metal, the heat dissipation of the case is further improved, and the strength of the case is also improved.

The device body may be accommodated in the case such that a winding axis of the coil unit of the wire is substantially parallel to a bottom surface of the case, or the device body may be accommodated in the case such that the winding axis of the coil unit of the wire is substantially perpendicular to the bottom surface of the case.

In a horizontal coil device in which the winding axis of the coil unit is substantially parallel to the bottom surface of the case, it is possible to easily reduce the height as compared with a vertical coil device in which the winding shaft of the wire is substantially perpendicular to the bottom surface of the case, and it is easy to promote heat dissipation cooling from the wire to the case. Furthermore, the vertical coil device has an advantage that heat dissipation from the core to the case is easily improved as compared with the horizontal coil device.

A length of the support arm may be shorter or longer than a width of the support arm. By making the length of the support arm longer, it is easy to separate a connection position between the terminal attached to the terminal block supported by the support arm and the external circuit substrate from the case. Furthermore, by making the width of the support arm shorter than a side wall width of the case, it is easy to dispose a plurality of the support arms at the same height position of a side wall of the case.

Preferably, a width of the support arm located at a connection portion with the case is larger than a width of a distal end portion of the support arm, and the support arm is integrated with the case in a cantilever shape. With such a configuration, it is easy to improve the strength of the support arm integrated with the case in a cantilever shape.

Preferably, the terminal block is configured of an insulating material, and includes a cover portion that covers at least an upper surface of the support arm along a direction in which the support arm extends. With such a configuration, the lead portion of the wire can be easily disposed on the cover portion having insulating properties. Furthermore, even if the support arm is made of metal, it is easy to ensure insulation between the lead portion of the wire and the support arm.

Preferably, the cover portion includes an engagement piece that guides the lead portion of the wire along the direction in which the support arm extends. With such a configuration, the lead portion of the wire can be easily disposed along a longitudinal direction of the cover portion.

Preferably, the support arm is disposed at an intermediate position between an upper end and a lower end of the case. With such a configuration, it is easy to create a void space for disposing other circuit substrates, electronic components, and the like above and below the support arm.

The support arm may include an upper protrusion extending upward from the support arm. The terminal block may include a columnar member into which the upper protrusion is inserted, and a terminal to which a distal end of the lead portion is connected can be preferably attached to an upper portion of the columnar member. With such a configuration, positioning of the terminal disposed on an upper side of the support arm becomes easy, and a lead connecting portion between the lead portion of the wire and the terminal and an external connecting portion between the external circuit substrate and the like and the terminal can be vertically separated.

The support arm may include a lower protrusion extending downward from the support arm. The terminal block may include a member with an upper hole into which the lower protrusion is inserted, and a terminal to which a distal end of the lead portion is connected may be attachable to a lower portion of the member with an upper hole. With such a configuration, positioning of the terminal disposed on a lower side of the support arm becomes easy, and lead connection work becomes easy.

The lead portion drawn out from the wire of the coil unit may comprise a pair of the lead portions, and one lead portion may be disposed to pass through the terminal block located above the support arm, and the other lead portion may be disposed to pass through the terminal block located below the support arm. With this configuration, it becomes easy to secure an insulation distance between the terminal connected to the lead portion of the wire passing through an upper side of the support arm and the terminal connected to the lead portion of the wire passing through a lower side of the support arm.

Furthermore, the terminal connected to the lead portion of the wire passing through the upper side of the support arm and the terminal connected to the lead portion of the wire passing through the lower side of the support arm are easily displaced and disposed along the longitudinal direction of the support arm. Therefore, insulation between these terminals is easily secured.

The coil unit of the wire may include a coil unit of a pair of the wires. Furthermore, the bobbin may include a first bobbin around which one of the wires is wound and a second bobbin around which the other wire is wound, and the second bobbin is attached to the first bobbin. Moreover, the support arm may include at least two support arms. A plurality of the support arms may be provided on the same side surface of the case, or may be provided on different opposing (or adjacent) side surfaces.

### BRIEF DESCRIPTION OF THE SEVERAL VIEWS OF THE DRAWINGS

FIG. 1 is a schematic perspective view of a coil device according to an embodiment of the present invention;

FIG. 2 is an exploded perspective view of the coil device illustrated in FIG. 1;

FIG. 3 is an exploded perspective view of a bobbin illustrated in FIG. 2;

FIG. 4 is an exploded perspective view of the bobbin illustrated in FIG. 3 as viewed from a different angle;

FIG. 5 is an exploded perspective view illustrating a coil unit of a wire illustrated in FIG. 2;

FIG. 6 is an exploded perspective view of a terminal to which a lead portion of the wire illustrated in FIG. 5 is connected;

FIG. 7 is a schematic perspective view illustrating a state in which a bobbin cover is attached to the bobbin provided with the coil unit of the wire to which the terminal illustrated in FIG. 2 is attached;

FIG. 8 is an exploded perspective view of a core illustrated in FIG. 2;

FIG. 9 is an exploded perspective view of an upper terminal block and a support arm of a case before the upper terminal block is attached to the support arm included in the case;

FIG. 10 is an exploded perspective view of a lower terminal block and the support arm of the case before the lower terminal block is attached to the support arm included in the case;

FIG. 11 is a perspective view illustrating a state after the upper terminal block and the lower terminal block are attached to the support arm included in the case;

FIG. 12 is a plan view of the coil device illustrated in FIG. 1;

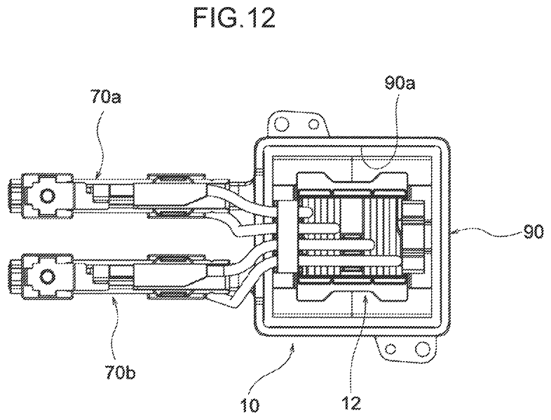

FIG. 13 is a bottom view of the coil device illustrated in FIG. 1;

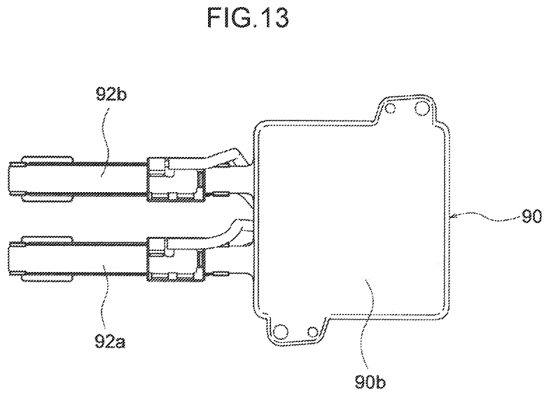

FIG. 14 is a longitudinal sectional view illustrating a use state of the coil device illustrated in FIG. 1;

FIG. 15 is a schematic perspective view of a coil device according to another embodiment of the present invention;

FIG. 16 is a plan view of the coil device illustrated in FIG. 15; and

FIG. 17 is a perspective view illustrating a case of the coil device illustrated in FIG. 15.

### DETAILED DESCRIPTION OF THE INVENTION

Hereinafter, description will be given based on embodiments illustrated in the drawings.

### First Embodiment

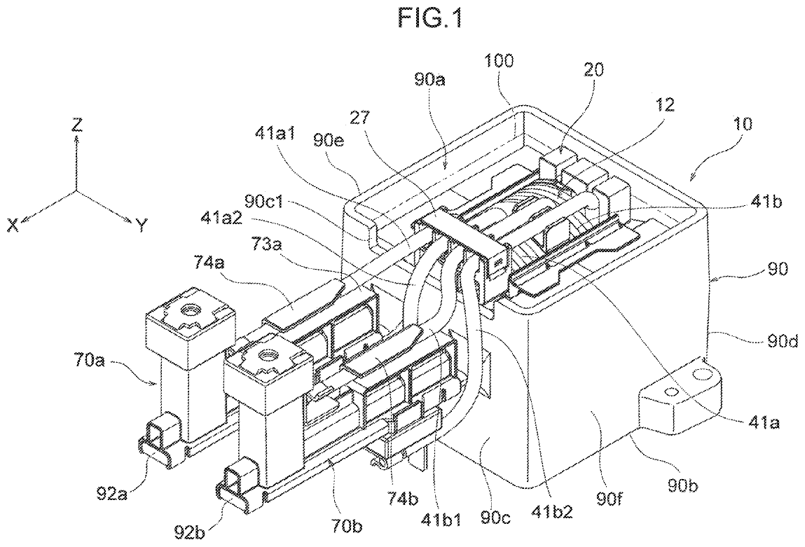

A coil device 10 according to the present embodiment illustrated in FIG. 1 functions as, for example, a transformer, and is used for, for example, an on-board charger for an electric vehicle (EV), a plug-in hybrid vehicle (PHV), or a commutator (vehicle), or a power supply circuit of a household or industrial electric device, or a power supply circuit of a computer device, or the like.

Hereinafter, a detailed configuration of the coil device 10 will be described. Note that, in the following description, an X axis, a Y axis, and a Z axis are perpendicular to each other in the drawings. The Z axis corresponds to a height direction (vertical direction) of the coil device 10. Furthermore, a side toward a center of the coil device 10 is defined as an inside or an inner side, and a side away from the center of the coil device 10 is defined as an outside or an outer side.

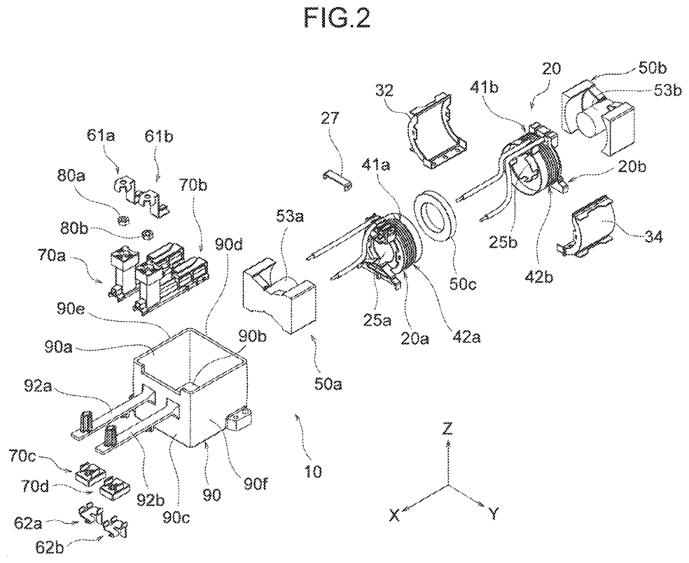

As illustrated in FIG. 1, the coil device 10 includes a device body 12 and a case 90 including an accommodation portion 91 that accommodates the device body 12. As illustrated in FIG. 2, the device body 12 includes a bobbin 20 and cores 50a and 50b. In the present embodiment, the bobbin 20 includes a first bobbin 20a, a second bobbin 20b, and bobbin covers 32 and 34.

A first wire 41a is wound around the first bobbin 20a, and a first coil unit 42a is formed. A second wire 41b is wound around the second bobbin 20b, and a second coil unit 42b is formed. An intermediate core 50c may be interposed between the separable first bobbin 20a and second bobbin 20b. Middle legs 53a and 53b of the cores 50a and 50b can be inserted into shaft holes 25a and 25b formed in the bobbins 20a and 20b from the outside of the bobbin 20 along the X axis.

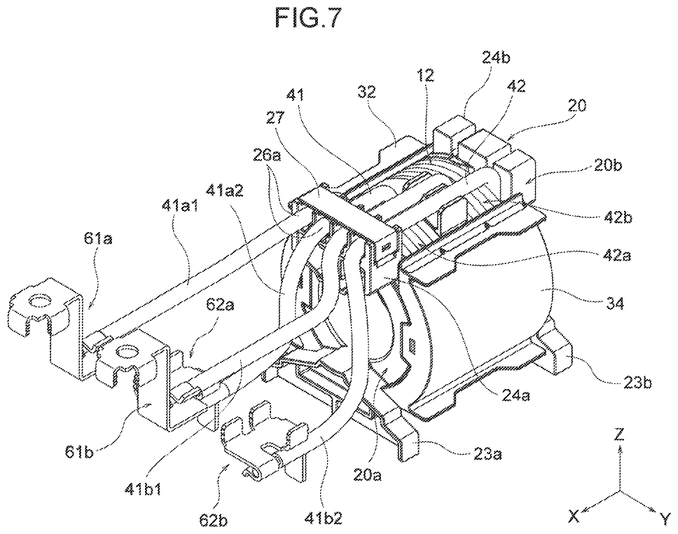

As illustrated in FIG. 7, the bobbin covers 32 and 34 are attached to the bobbin 20 in which the bobbins 20a and 20b are combined along the X axis from both sides along the Y axis. In the present embodiment, the device body 12 is accommodated from an upper opening 90a of the case 90 such that pedestals 23a and 23b of the bobbin 20 illustrated in FIG. 7 are installed on a bottom wall 90b of the case 90 illustrated in FIG. 2. As a result, winding shafts of the coil units 42a and 42b of the wires 41a and 41b become parallel to the bottom wall 90b of the case 90, and the coil device becomes a so-called horizontal coil device 10. Note that, in the present embodiment, the X axis coincides with the winding shafts of the coil units 42a and 42b of the wires 41a and 41b, but the present invention is not limited thereto.

In the present embodiment, a lower surface of the bottom wall 90b of the case 90 serves as an installation surface of the coil device 10, and the installation surface is provided with a cooling mechanism and the like, and is cooled from the bottom wall 90b of the case 90. As illustrated in FIG. 1, an inside (the accommodation portion 91) of the case 90 surrounded by side walls 90c to 90f and the bottom wall 90b is filled with heat dissipation resin 100, and heat generated from the device body 12 in contact with the heat dissipation resin 100 is transferred to the side walls 90c to 90f and the bottom wall 90b of the case 90 via the heat dissipation resin 100, and is dissipated from the bottom wall 90b. Note that a portion of the device body 12 that is in direct contact with the bottom wall 90b conducts heat from there to the bottom wall 90b for heat dissipation.

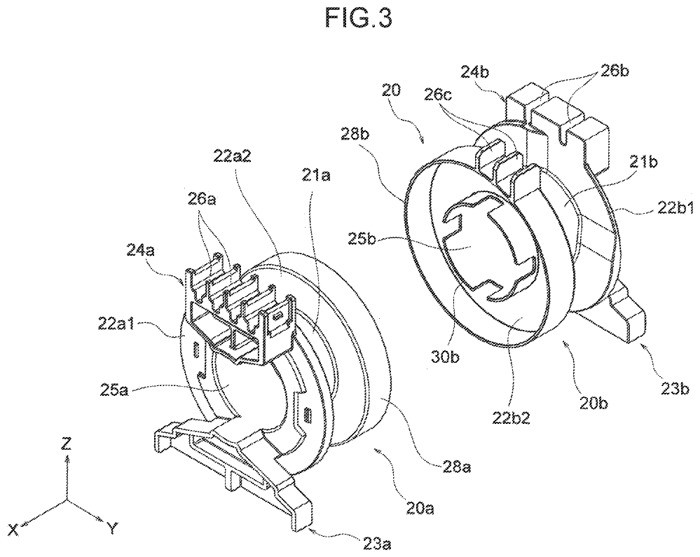

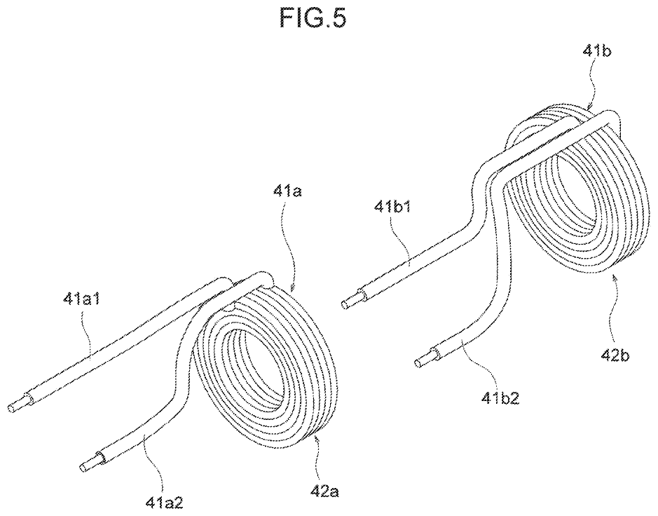

As illustrated in FIG. 3, the bobbin 20 includes the first bobbin 20a and the second bobbin 20b. The first bobbin 20a includes a tubular first winding core 21a, and the first wire 41a illustrated in FIG. 5 is wound around the first winding core to form the first coil unit 42a. Similarly, the second bobbin 20b illustrated in FIG. 3 includes a tubular second winding core 21b, and the second wire 41b illustrated in FIG. 5 is wound around the second winding core to form the second coil unit 42b. As illustrated in FIG. 5, first lead portions 41a1 and 41a2 located at both ends of the first wire 41a are drawn out from the first coil unit 42a, and second lead portions 41b1 and 41b2 located at both ends of the second wire 41b are drawn out from the second coil unit 42b.

As illustrated in FIG. 3, flanges 22a1 and 22a2 are integrally provided at both ends of the first winding core 21a along the winding shaft (X axis) so as to expand from the winding core 21a in a radial direction. The pedestal 23a is integrally provided below one flange 22a1 along the Z axis so as to protrude outward along the X axis of the flange 22a1. Furthermore, a guide protrusion 24a is integrally provided above the flange 22a1 along the Z axis so as to protrude outward along the X axis of the flange 22a 1. A plurality of guide grooves 26a are formed along the Y axis on an upper side of the guide protrusion 24a along the Z axis.

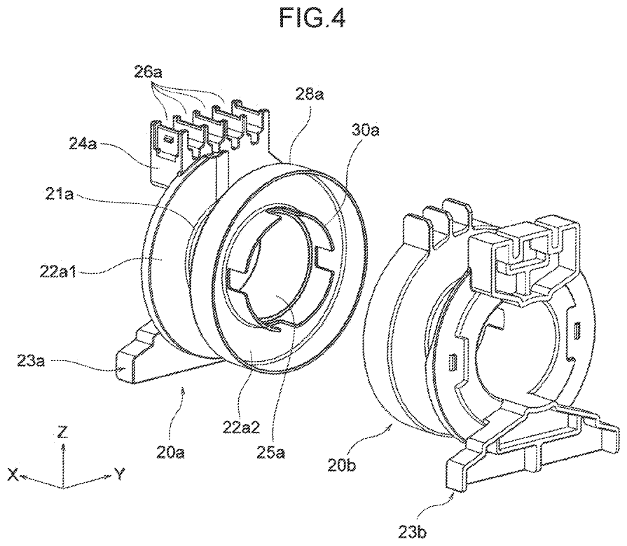

The lead portions 41a1, 41a2, 41b1, and 41b2 of the wires 41a and 41b illustrated in FIG. 5 are passed through and guided by the guide grooves 26a. As illustrated in FIG. 4, a bottom of each of the grooves 26a is preferably located at a position higher than an outer diameter of the flange 22a1 along the Z axis. The guide grooves 26a guide the lead portions 41a1, 41a2, 41b1, and 41b2 illustrated in FIG. 3 outward along the X axis of the first bobbin 20a in parallel along the X axis.

On an outer peripheral edge of the other flange 22a2, an outer frame 28a protrudes in a tubular shape in a direction opposite to the winding core 21a along the X axis and is integrally provided. As illustrated in FIG. 4, an inner frame 30a is provided inside the outer frame 28a of the flange 22a2 so as to be concentric with the outer frame 28a and protrude from the shaft hole 25a of the winding core 21a in the same direction as the outer frame 28a.

Furthermore, as illustrated in FIG. 3, flanges 22b1 and 22b2 are integrally provided at both ends of the second winding core 21b along the winding shaft (X axis) so as to expand from the winding core 21b in the radial direction. The pedestal 23b is integrally provided below one flange 22b1 along the Z axis so as to protrude outward along the X axis of the flange 22b1. Furthermore, a protrusion 24b is integrally provided above the flange 22b1 along the Z axis so as to protrude outward along the X axis of the flange 22b1. On an upper side along the Z axis of the protrusion 24b, a plurality of grooves 26b are formed along the Y axis so as to communicate along the X axis.

In the present embodiment, each of the grooves 26b is provided in consideration of formability in the protrusion 24b, and does not pass through any of the lead portions 41a1, 41b1, 41a2, and 41b2 of the wires as illustrated in FIG. 5, but may be used as a guide groove for passing through any of the lead portions.

On an outer peripheral edge of the other flange 22b2, an outer frame 28b protrudes in a tubular shape in a direction opposite to the winding core 21b along the X axis and is integrally provided. An inner frame 30b is provided inside the outer frame 28b of the flange 22b2 so as to be concentric with the outer frame 28b and protrude from the shaft hole 25b of the winding core 21b in the same direction as the outer frame 28a. A plurality of partition walls are formed in an upper portion of the outer frame 28b along the Z axis so as to protrude from an outer peripheral surface of the outer frame 28b along the Y axis, and grooves 26c communicating with each other along the X axis are formed between the partition walls.

In the present embodiment, each of the groove 26c does not pass through any of the lead portions 41a1, 41b1, 41a2, and 41b2 of the wires as illustrated in FIG. 5, but may be used as a guide groove for passing any of the lead portions.

In order to combine the first bobbin 20a and the second bobbin 20b illustrated in FIG. 3, for example, the intermediate core 50c illustrated in FIG. 2 is fitted between the outer frame 28a and the inner frame 30a illustrated in FIG. 4, the outer frame 28a illustrated in FIG. 3 is fitted inside the outer frame 28b, and the inner frame 30a illustrated in FIG. 4 is fitted outside the inner frame 30b illustrated in FIG. 3. Thereafter, as illustrated in FIG. 7, the bobbin covers 32 and 34 are attached to both sides in the Y axis direction of the combined bobbins 20a and 20b.

Note that before combining the first bobbin 20a and the second bobbin 20b, it is preferable to form the coil units 42a and 42b by winding each the wires 41a and 41b illustrated in FIG. 5 around the outer periphery of each of the winding cores 21a and 21b. Furthermore, the bobbins 20a and 20b and the bobbin covers 32 and 34 are preferably made of insulating materials, but are not necessarily made of the same material.

The bobbins 20a and 20b are formed by, for example, injection molding, and the material thereof is not particularly limited, but is configured of, for example, PBT, PET, LCP, PA, PPS, or a phenol resin from the viewpoint of heat resistance. The bobbin covers 32 and 34 can also be configured of the same material as the bobbin 20, but may be made of an insulating material other than resin, for example, ceramic, paper, or the like in order to have a simple shape. The bobbin 20 may also be configured of an insulating material other than resin as long as it can be formed.

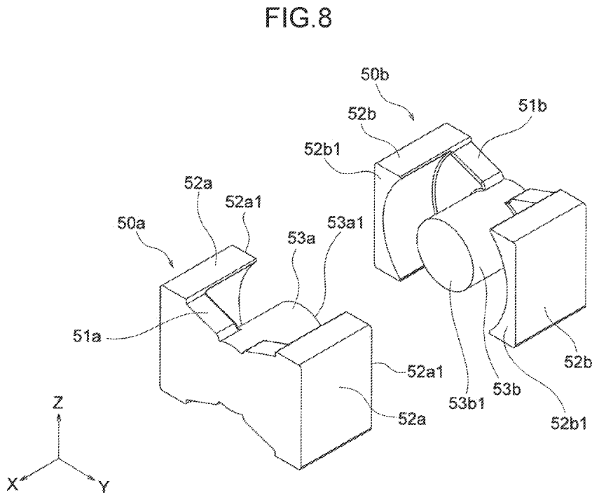

As illustrated in FIG. 8, each of the core 50a and the core 50b is a so-called E-shaped core, and is attached to the bobbin 20 after combination illustrated in FIG. 7. Examples of the material of the cores 50a and 50b include, but are not particularly limited to, a magnetic material such as a metal magnetic material or ferrite. Note that the intermediate core 50c is also configured of the same material as the cores 50a and 50b, but these are not necessarily configured of the same material.

The cores 50a and 50b have the same shape (for example, E-type and E-type), but may have different shapes (for example, E-type and I-type). In the present embodiment, the core 50a includes a base 51a, a pair of outer legs 52a, and the middle leg 53a. The core 50b includes a base 51b, a pair of outer legs 52b, and the middle leg 53b. Hereinafter, the configuration of the core 50a will be described, but the description of the core 50a also applies to the core 50b. Therefore, the description of the configuration of the core 50b will be omitted unless otherwise necessary.

The base 51a has a predetermined thickness along the X axis and a predetermined length along each of the Y axis and the Z axis. A recessed portion 55a recessed upward along the Z axis at a position of the middle leg 53a is formed on a lower surface of the base 51a. The recessed portion is formed substantially in a center of the base with respect to the Y axis, and has a predetermined width along the X axis and the Y axis.

The middle leg 53a is disposed between the pair of outer legs 52a. The middle leg 53a extends by a predetermined length along the X-axis, and a distal end surface 53a1 of the middle leg 53a along the X-axis may be flush with distal end surfaces 52a1 and 52a1 of the outer leg 52a, or may be slightly recessed from the distal end surfaces 52a1 and 52a1.

The middle leg 53a is inserted into the shaft hole 25a of the bobbin 20 illustrated in FIG. 3. The middle leg 53a of the core 50a and the middle leg 53b of the core 50b are disposed inside the shaft holes 25a and 25b in a state where the end surfaces 53a1 and 53b1 are butted against each other.

Note that a gap may be formed along the X axis between the end face 53a1 of the middle leg 53a and the end face 53b1 of the middle leg 53b. The distal end surfaces 52a1 and 52a1 of the outer leg 52a and the distal end surfaces 52b1 and 52b1 of the outer leg 52b are preferably butted against each other, and these distal end surfaces may be joined to each other with an adhesive or the like.

The outer legs 52a and 52b illustrated in FIG. 8 are disposed on outer surfaces of the bobbin covers 32 and 34 illustrated in FIG. 7. The base 51a of one core 50a illustrated in FIG. 8 is disposed between the pedestal 23a and the protrusion 24a illustrated in FIG. 7, and the base 51b of the other core 50b illustrated in FIG. 8 is disposed between the pedestal 23b and the protrusion 24b illustrated in FIG. 7.

In the present embodiment, a cross-section (a cross section perpendicular to the X axis) of the middle leg 53a (53b) illustrated in FIG. 8 is circular, but may be elliptical, polygonal, a downwardly bulging shape, or other shapes.

As illustrated in FIG. 7, the lead portions 41a1 and 41a2 of the wire drawn out from the coil unit 42a and the lead portions 41b1 and 41b2 of the wire drawn out from the coil unit 42b are passed through the guide groove 26a formed in the upper portion of the protrusion 24a. A groove cover 27 is attached to the protrusion 24a such that an upper side of the guide groove 26a through which the lead portions 41a1, 41a2, 41b1, and 41b2 pass is covered with the groove cover 27.

Terminals 61a, 62a, 61b, and 62b are connected to the distal ends of the lead portions 41a1, 41a2, 41b1, and 41b2, respectively. In the present embodiment, these terminals 61a, 62a, 61b, and 62b are not particularly limited, but are configured of a metal such as copper, a copper alloy, iron, or an iron alloy, for example.

The wires 41a and 41b including the lead portions 41a1, 41a2, 41b1, and 41b2 connected to the terminals 61a, 62a, 61b, and 62b are not particularly limited, and for example, conductive wires such as insulation-coated copper, copper alloy, iron, iron alloy, and CP wire are used for the wires 41a and 41b. The insulating material constituting the insulating coating is not particularly limited, but polyurethane, polyamideimide, ETFE, or the like is used.

As illustrated in FIG. 7, among the terminals 61a, 62a, 61b, and 62b, one terminal 61a or 61b and the other terminal 62a or 62b have shapes different from each other, and the one terminal 61a or 61b are disposed above the other terminal 62a or 62b along the Z axis in a state of being attached to a terminal block to be described later.

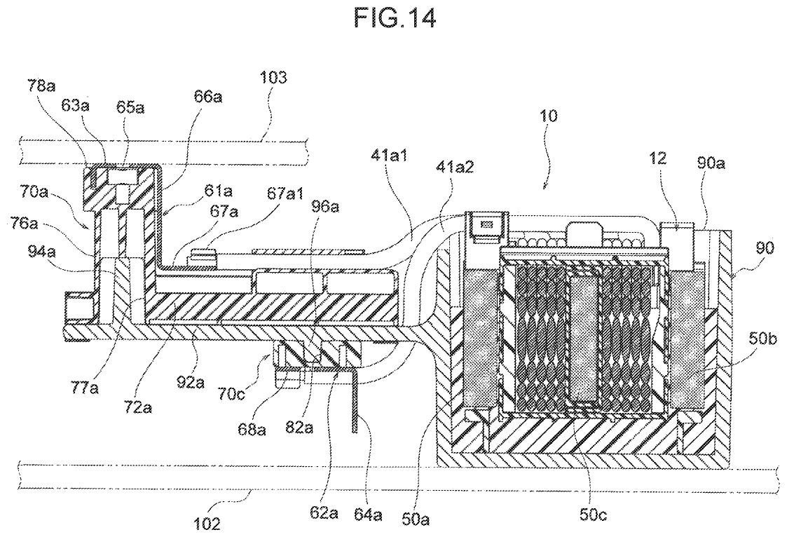

The terminals 61a and 61b on one side have the same shape as each other, and includes external connection portions 63a and 63b, joining portions 67a and 67b, and communication portions 66a and 66b, which are integrally formed by bending a conductive plate configured of metal or the like by press working or the like. Connection holes 65a and 65b are formed in the external connection portions 63a and 63b, respectively. The connection holes 65a and 65b formed in the external connection portions 63a and 63b are used, for example, to connect the terminals 61a and 61b to a circuit pattern of an external circuit substrate 103 illustrated in FIG. 14.

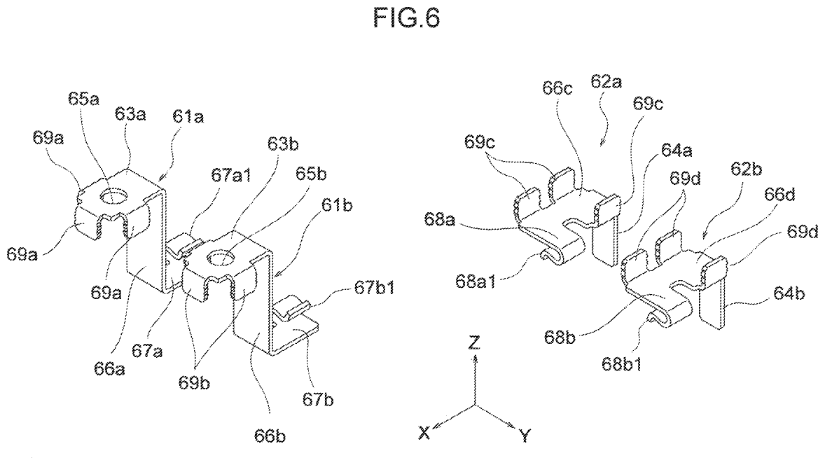

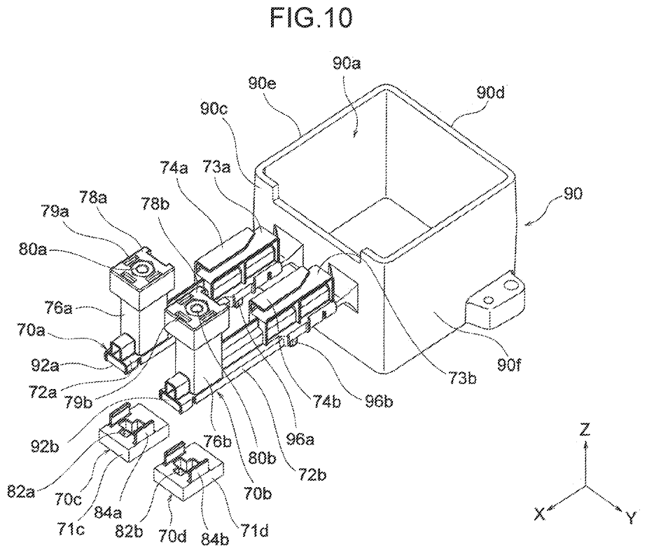

As illustrated in FIG. 6, a plurality of attachment claws 69a and 69b are bent and formed downward in the Z axis around the external connection portions 63a and 63b, respectively. The attachment claws 69a and 69b can be inserted into attachment grooves 79a and 79b formed in upper terminal holding surfaces 78a and 78b of upper terminal blocks 70a and 70b illustrated in FIG. 10. As a result, the external connection portions 63a and 63b of the terminals 61a and 61b can be positioned and fixed to the upper terminal holding surfaces 78a and 78b of the upper terminal blocks 70a and 70b.

Note that fasteners such as nuts 80a and 80b are disposed on the upper terminal holding surfaces 78a and 78b of the upper terminal blocks 70a and 70b, respectively, and the connection holes 65a and 65b and screw holes or the like of the nuts 80a and 80b illustrated in FIG. 6 are aligned.

As illustrated in FIG. 6, the communication portions 66a and 66b are connection pieces for communicating between the external connection portions 63a and 63b and the joining portions 67a and 67b disposed at positions having different heights along the Z axis, respectively. In the present embodiment, the connection pieces may be disposed in parallel along the Z axis, but may be inclined.

The joining portions 67a and 67b are disposed substantially parallel to the external connection portions 63a and 63b, and protrude to an opposite side of the communication portions 66a and 66b from the external connection portions 63a and 63b. The joining portions 67a and 67b include folded pieces 67a1 and 67b1, respectively, and sandwich the tips of the lead portions 41a1 and 41b1 illustrated in FIG. 7 between the folded pieces 67a1 and 67b1 and the plate-shaped joining portions 67a and 67b, respectively, and the terminals 61a and 61b and the lead portions 41a1 and 41b1 can be connected to each other by connecting means such as thermocompression bonding.

As illustrated in FIG. 14, the joining portion 67a (same for the joining portion 67b/omitted below) is preferably disposed substantially parallel to a cover portion 72a (same for a cover portion 72b/omitted below) of the upper terminal block 70a (same for the upper terminal block 70b/omitted below) with a void therebetween, but may be in contact with the cover portion 72a. Since the joining portion 67a and the cover portion 72a are not fixed, and the communication portion 66a (same for the communication portion 66b/omitted below) and a columnar member 76a (same for a columnar member 76b/omitted below) are not fixed, a distance between the external connection portion 63a (same for the external connection portion 63b/omitted below) and the joining portion 67a can be displaced. Therefore, the influence of thermal deformation, vibration, or the like of the substrate 103 is less likely to be transmitted from the external connection portion 63a to the joining portion 67a, and the connection reliability with the lead portion in the joining portion 67a is improved.

As illustrated in FIG. 6, the terminals 62a and 62b on the other side have the same shape, and include external connection portions 64a and 64b, joining portions 68a and 68b, and communication portions 66c and 66d, which are integrally formed by bending metal plates by press working or the like.

The external connection portions 64a and 64b are portions connected to, for example, a capacitor or other electronic components (not illustrated) installed on an installation substrate 102 illustrated in FIG. 14. Furthermore, the external connection portions 64a and 64b may be connected to, for example, a circuit pattern of a circuit substrate (not illustrated) disposed between the installation substrate 102 and a support arm 92a illustrated in FIG. 14. Note that, although only the external connection portion 64a of the terminal 62a is illustrated in FIG. 14, the same applies to the external connection portion 64b of the terminal 62b.

As illustrated in FIG. 6, the joining portions 68a and 68b and the external connection portions 64a and 64b are communicated by the communication portions 66c and 66d. The communication portions 66c and 66d are flush with the joining portions 68a and 68b, respectively, and are substantially parallel to a plane including the X axis and the Y axis.

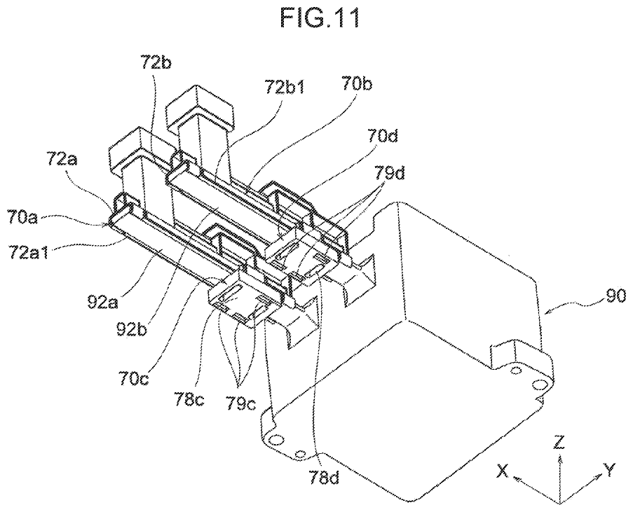

Attachment claws 69c and 69d are formed by bending upward on the Z axis on both sides of the communication portions 66c and 66d along the Y axis and on one side of the joining portions 68a and 68b along the Y axis, respectively. The attachment claws 69c and 69d can be inserted into attachment grooves 79c and 79d formed in lower terminal holding surfaces 78c and 78d of lower terminal blocks 70c and 70d illustrated in FIG. 11. As a result, the external connection portions 64a and 64b and the communication portions 66c and 66d of the terminals 62a and 62b illustrated in FIG. 6 can be positioned and fixed to the lower terminal holding surfaces 78c and 78d of the lower terminal blocks 70c and 70d illustrated in FIG. 11.

The joining portions 68a and 68b are disposed substantially perpendicular to the external connection portions 64a and 64b, and are provided on substantially the same plane with respect to the communication portions 66a and 66b. The joining portions 68a and 68b include folded pieces 68a1 and 68b1 folded downward along the Z axis from the edges of the joining portions 68a and 68b in the Y axis direction, respectively. The distal ends of the lead portions 41a2 and 41b2 illustrated in FIG. 6 are sandwiched between the folded pieces 68a1 and 68b1 and the plate-shaped joining portions 68a and 68b, and the terminals 62a and 62b and the lead portions 41a2 and 41b2 can be connected by connection means such as thermocompression bonding.

As illustrated in FIG. 14, the joining portion 68a (same for the joining portion 68b) is disposed under the lower terminal block 70c (same for the lower terminal block 70d) and is preferably in close contact with a lower surface of the lower terminal block 70c (same for the lower terminal block 70d), but there may be a void.

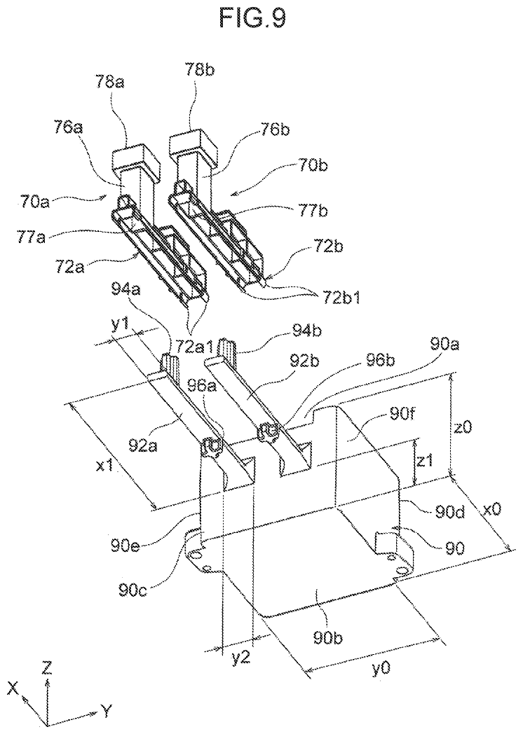

As illustrated in FIG. 9, the case 90 includes a bottom wall 90b parallel to the X axis and the Y axis, and four side walls 90c to 90f, and includes an upper side opened along the Z axis to form an upper opening 90a. A size of the case 90 is not particularly limited, and has a length of x0 along the X axis, a width of y0 along the Y axis, and a height of z0 along the Z axis. These dimensions are not particularly limited, and are set to a size that allows substantially the entire device body 12 to be accommodated inside the case 90, for example, as illustrated in FIG. 1.

Furthermore, the inside of the case 90 is filled with the heat dissipation resin 100, and most of the device body 12, at least the lower half or more of the device body 12 is immersed in the heat dissipation resin 100. A liquid level of the heat dissipation resin 100 may be lower than a bottom position of a notch 90c1 provided in an upper edge of the side wall 90c defining a part of the upper opening 90a of the case 90, for example, and a part of the upper portion of the device body 12 may protrude upward from the liquid level of the heat dissipation resin 100.

As illustrated in FIG. 9, in the present embodiment, a pair of support arms 92a and 92b is formed on an outer surface of the side wall 90c of the case 90 so as to protrude along the X axis. In the present embodiment, the case 90 is configured of metal such as aluminum together with the support arms 92a and 92b, and is manufactured by, for example, a die cast method, a cast method, or the like, but may be molded by other methods.

Furthermore, the case 90 may be configured of resin having excellent heat dissipation together with the support arms 92a and 92b. However, a metal case is more excellent in heat dissipation than the resin case. Furthermore, the support arms 92a and 92b may be formed and joined separately from the case 90, but in order to improve the joint strength, it is preferable to form them integrally.

Each of the support arms 92a and 92b has a width y1 along the Y axis uniform along the X axis except for a width y2 along the Y axis on a proximal end side close to the side wall 90c. The width y2 on the proximal end side is preferably larger than the width y1 on a distal end side of the support arms 92a and 92b. With this configuration, the support arms 92a and 92b and the case 90 can be easily formed integrally, and the support arms 92a and 92b can be joined to the side wall 90c of the case 90 in a cantilever shape with high strength.

The widths y1 and y2 of the support arms 92a and 92b are preferably smaller than or equal to the width y0 of the case 90. In a case where n (n is two or more) support arms 92a and 92b are formed at the same height along the Z axis on the same side surface 90c, the widths y1 and y2 of the support arms 92a and 92b are preferably 1/n or less of the width y0 of the case 90. In the present embodiment, the widths y1 and y2 of the support arms 92a and 92b are within a range of ⅛ to ½ of the width y0 of the case 90.

In the present embodiment, a length x1 by which each of the support arms 92a and 92b protrudes from the outer surface of the side wall 90c along the X axis is preferably longer than the widths y1 and y2 of each of the support arms 92a and 92b, but may be shorter. By making the length x1 of each of the support arms 92a and 92b longer than the widths y1 and y2 of each of the support arms 92a and 92b, upper protrusions 94a and 94b provided on the distal end side of each of the support arms 92a and 92b and lower protrusions 96a and 96b provided on the proximal end side can be easily pulled apart along the X axis.

The upper protrusions 94a and 94b protrude upward along the Z axis from the upper surfaces on the distal end sides of the support arms 92a and 92b, and the lower protrusions 96a and 96b protrude downward along the Z axis from the lower surfaces on the proximal end sides of the support arms 92a and 92b. In the present embodiment, a protrusion height of the upper protrusions 94a and 94b from the support arms 92a and 92b is larger than a protrusion height of the lower protrusions 96a and 96b from the support arms 92a and 92b, but is not limited thereto. The shape of the cross-section (cross section perpendicular to the Z axis) of each of the protrusions 94a, 94b, 96a, and 96b is a substantially cross shape in the present embodiment, but may be other shapes.

In the present embodiment, the upper protrusions 94a and 94b are respectively fitted into lower holes 77a and 77b formed on the lower surfaces on the distal end sides of the upper terminal blocks 70a and 70b along the X axis. Furthermore, as illustrated in FIG. 14, the lower protrusions 96a and 96b are fitted into upper hole 82a (and 82b similarly) of the lower terminal block 70c (and 70d similarly).

As illustrated in FIG. 9, a height z1 at which proximal end lower surfaces of the support arms 92a and 92b intersect the outer surface of the side wall 90c of the case 90 is smaller than the height z0 of the case 90, preferably within a range of ⅛ to ⅞ of z0, and more preferably within a range of ¼ to ¾ of z0.

The upper terminal blocks 70a and 70b include the cover portions 72a and 72b, respectively. The cover portions 72a and 72b are configured to cover the upper surfaces of the support arms 92a and 92b along the Z axis. As illustrated in FIG. 11, gripping pieces 72a1 and 72b1 are integrally provided on both sides of the cover portions 72a and 72b along the Y axis, respectively. Each of a pair of the gripping pieces 72a1 and 72b1 covers both ends of the support arms 92a and 92b along the Y axis, and can be engaged with each of the support arms 92a and 92b in a one-touch manner by an elastic force of the gripping pieces 72a1 and 72b1.

As illustrated in FIG. 10, height adjusting portions 73a and 73b are respectively provided at positions close to case 90 along the longitudinal direction of upper terminal blocks 70a and 70b so as to protrude in the Z-axis direction from the upper parts of the cover portions 72a and 72b. The height adjusting portions 73a and 73b are formed integrally with the cover portions 72a and 72b, respectively. On the height adjusting portions 73a and 73b, engagement pieces 74a and 74b are provided integrally with the height adjusting portions 73a and 73b, respectively.

The lead portions 41a1 and 41b1 pass between the engagement pieces 74a and 74b and the upper surfaces of the height adjusting portions 73a and 73b, respectively, and the distal ends of the lead portions 41a1 and 41b1 are guided further outward along the X axis.

As illustrated in FIG. 9, tubular columnar members (members with lower holes) 76a and 76b protruding upward along the Z axis from above the cover portions 72a and 72b are integrally provided on the distal end side along the X axis of the upper terminal blocks 70a and 70b. As illustrated in FIG. 14, the lower hole 77a (same for the lower hole 77b/omitted below) is formed below the columnar member 76a (same for the columnar member 76b/omitted below) along the Z axis, and the lower half or more of the columnar member 76a along the Z axis is hollow and communicates with the lower hole 77a.

The upper protrusion 94a (same for the upper protrusion 94b/omitted below) of the support arm 92a (the support arm 92b/omitted below) is fitted into the lower hole 77a, thereby enabling the positioning of the support arm 92a (the support arm 92b/omitted below) and the terminal block 70a (same for the terminal block 70b/omitted below), as well as strengthening the joint between the terminal block 70a and the support arm 92a.

The terminal holding surface 78a (same for the terminal holding surface 78b/omitted below) is formed on a top surface of the columnar member 76a along the Z axis. As described above, the external connection portion 63a (same for the external connection portion 63b/omitted below) of the terminal 61a (same for the terminal 61b/omitted below) is attached to the terminal holding surface 78a. The communication portion 66a (same for the communication portion 66b/omitted below) of the terminal 61a is guided below the Z axis along the outer surface of the side wall of the columnar member 76a on a side of the case 90. Since the external connection portion 63a of the terminal 61a is fixed to the terminal holding surface 78a of the columnar member 76a, there may be a void between the communication portion 66a and the outer surface of the side wall of the columnar member 76a, and it is not necessary to connect them with an adhesive or the like, but they may be bonded.

As illustrated in FIG. 10, the lower terminal blocks 70c and 70d include flat plate-shaped main plate portions (materials with upper holes) 71c and 71d, and the upper holes 82a and 82b are provided substantially at the centers of the upper surfaces of the main plate portions 71c and 71d. On both sides along the Y axis of each of the upper holes 82a and 82b, engagement pieces 84a and 84a or engagement pieces 84b and 84b are provided so as to protrude upward along the Z axis from the main plate portions 71c and 71d, respectively.

The lower protrusions 96a and 96b included in the support arms 92a and 92b can be fitted into the upper holes 82a and 82b of the lower terminal blocks 70c and 70d, respectively, and the lower terminal blocks 70c and 70d can be positioned and fixed to the lower surfaces of the support arms 92a and 92b, respectively.

Furthermore, the engagement pieces 84a and 84a or the engagement pieces 84b and 84b of the lower terminal blocks 70c and 70d are engaged with the outer surfaces of the gripping pieces 72a1 and 72b1 provided on both sides along the Y axis of the upper terminal blocks 70a and 70b, and the lower terminal blocks 70c and 70d can be connected to the upper terminal blocks 70a and 70b. Note that the engagement pieces 84a and 84a or the engagement pieces 84b and 84b of the lower terminal blocks 70c and 70d may be directly connected to the support arms 92a and 92b.

As illustrated in FIG. 11, the attachment grooves 79c and 79d are formed on lower surfaces of the lower terminal blocks 70c and 70d along the Z axis, and the terminals 62a and 62b illustrated in FIG. 6 can be attached.

In the present embodiment, the upper terminal block 70a (70b) and the lower terminal block 70c (70d) are separately formed and integrated via the support arms 92a (92b). The terminal blocks 70a (70b) and 70c (70d) are preferably configured of an insulating material, and are preferably configured of, for example, the same resin as the material constituting the bobbin 20. However, the resin of the terminal blocks 70a (70b) and 70c (70d) and the resin of the material constituting the bobbin 20 may be the same or different.

In the coil device 10 of the present embodiment, the support arms 92a and 92b extending to the outside of the case 90 are provided, one terminal block 70a or 70c is held by one support arm 92a, and the other terminal block 70b or 70d is held by the other support arm 92b. Therefore, it is not necessary to increase an installation area of the case 90 corresponding to areas of the terminal blocks 70a to 70d, and the installation area of the case 90 can be reduced. Furthermore, since it is not necessary to dispose the terminal blocks 70a to 70d on the case 90, it is possible to reduce the height of the case 90, that is, to reduce the height of the coil device 10.

Furthermore, as illustrated in FIG. 1, by filling the inside of the case 90 with the heat dissipation resin 100 such as a potting resin, heat from the wires 41a and 41b or the bobbin 20 (including the cores 50a to 50c) can be released to the bottom wall 90b of the case 90 via the heat dissipation resin 100, and the heat dissipation is improved. Furthermore, the terminal blocks 70a (70c) and 70b (70d) are supported by the support arms 92a and 92b protruding outward from the side wall 90c of the case 90, respectively. As a result, most of the bobbin (including the wires and the cores) 20 including at least the winding shafts of the wires 41a and 41b can be brought into contact with the heat dissipation resin 100 inside the case 90 without being hindered by the terminal blocks 70a to 70d. Therefore, the heat dissipation can be effectively enhanced by the minimum required heat dissipation resin.

Furthermore, as illustrated in FIG. 14, a void space can be formed between the surface of the substrate 102 or the like on which the case 90 is installed and the support arms 92a and 92b, and other circuit substrates and electronic components (for example, capacitors) thereof can be disposed in the void space, and a space on the substrate 102 on which the case 90 is installed can be effectively utilized.

Furthermore, the support arms 92a and 92b are formed integrally with the case 90. Since the support arms 92a and 92b formed integrally with the outer wall of the case 90 support the terminal blocks 70a to 70d, the strength and reliability of the terminal blocks 70a to 70d can be improved. In particular, when connecting the terminals 61a and 61b provided on the terminal blocks 70a and 70b of the coil device 10 to the external substrate 103 illustrated in FIG. 14, for example, the support arms 92a and 92b are easily connected to the substrate 103 to reinforce the strength of the terminal blocks 70a and 70b, and the reliability is improved. Furthermore, since the case 90 is made of metal, the heat dissipation of the case 90 is further improved, and the strength of the case 90 and the support arms 92a and 92b is also improved.

Furthermore, in the present embodiment, since the coil device is a horizontal coil device 10 in which the winding axes of the coil units 42a and 42b are substantially parallel to the bottom wall 90b of the case 90, it is possible to easily reduce the height as compared with a vertical coil device in which the winding shaft of the wire is substantially perpendicular to the bottom wall 90b of the case 90, and it is easy to promote heat dissipation cooling from the wires 41a and 41b to the case 90.

In the present embodiment, by increasing the lengths of the support arms 92a and 92b, it is easy to separate the connection positions between the terminals 61a and 61b attached to the terminal blocks 70a and 70b supported by the support arms 92a and 92b and the external circuit substrate 103 and the like from the case 90. Furthermore, by making the widths of the support arms 92a and 92b shorter than the side wall width of the case 90, the plurality of support arms 92a and 92b can be easily disposed at the same height position of the side wall 92c of the case 90.

Furthermore, as illustrated in FIG. 9, the width y2 of the support arms 92a and 92b located at the connection portion with the case 90 is larger than the width y1 of the distal end portions of the support arms 92a and 92b, and the support arms 92a and 92b are integrated with the case 90 in a cantilever shape. With such a configuration, it is easy to improve the strength of the support arms 92a and 92b integrated in a cantilever shape with the side wall 92c of the case 90.

Furthermore, the terminal blocks 70a and 70b are configured of an insulating material, and include cover portions 72a and 72b that cover at least upper surfaces of the support arms 92a and 92b along an extending direction of the support arms 92a and 92b. With such a configuration, it is easy to dispose the lead portions 41a1 and 41b1 of the wires 41a and 41b on the cover portions 72a and 72b having insulating properties. Furthermore, even if the support arms 92a and 92b are made of metal, it is easy to ensure insulation between the lead portions 41a1 and 41b1 of the wires 41a and 41b and the support arms 92a and 92b.

Moreover, the cover portions 72a and 72b include the engagement pieces 74a and 74b that guide the lead portions 41a1 and 41b1 of the wires 41a and 41b along the extending direction of the support arms 92a and 92b. With this configuration, the lead portions 41a1 and 41b1 of the wires 41a and 41b are easily disposed along the longitudinal direction of the cover portions 72a and 72b.

Furthermore, as illustrated in FIG. 9, the support arms 92a and 92b are disposed at an intermediate position between the upper end and the lower end of the case 90. With this configuration, as illustrated in FIG. 14, it is easy to create a void space for disposing other circuit substrates 103, electronic components, and the like above and below the support arms 92a and 92b.

Moreover, in the present embodiment, the support arms 92a and 92b include the upper protrusions 94a and 94b extending upward from the support arms 92a and 92b, and the terminal blocks 70a and 70b include the columnar members 76a and 76b into which the upper protrusions 94a and 94b are inserted. Moreover, the terminals 61a and 61b to which the distal ends of the lead portions 41a1 and 41b1 are connected can be attached to the upper portions of the columnar members 76a and 76b. With this configuration, the terminals 61a and 61b disposed on the upper side of the support arms 92a and 92b along the Z axis can be easily positioned, and the lead connection portions between the lead portions 41a1 and 41b1 of the wires 41a and 41b and the terminals 61a and 61b and the external connection portions between the external circuit substrate 103 or the like and the terminals 61a and 61b can be separated in the vertical direction.

In the present embodiment, the support arms 92a and 92b include the lower protrusions 96a and 96b extending downward from the support arms 92a and 92b. The lower terminal blocks 70c and 70d include main plate portions 71c and 71d as members with upper holes into which the lower protrusions 96a and 96b are inserted. The terminals 62a and 62b to which the distal ends of the lead portions 41a2 and 41b2 are connected can be attached to lower portions of the main plate portions 71c and 71d. With such a configuration, positioning of the terminals 62a and 62b disposed under the support arms 92a and 92b becomes easy, and lead connection work becomes easy.

In the present embodiment, one lead portion 41a1 or 41b1 of the pair of lead portions drawn out from the wires 41a and 41b of the coil units 42a and 42b passes through the terminal block 70a or 70b located above the support arms 92a and 92b, and the other lead portion 41a2 or 41b2 passes through the terminal block 70c or 70d located below the support arms 92a and 92b. With this configuration, it is easy to secure an insulation distance between the terminals 61a and 61b connected to the lead portions 41a1 and 41b1 of the wires 41a and 41b passing above the support arms 92a and 92b and the terminals 62a and 62b connected to the lead portions 41a2 and 41b2 of the wires 41a and 41b passing below the support arms 92a and 92b.

Furthermore, the terminals 61a and 61b connected to the lead portions 41a1 and 41b1 of the wires 41a and 41b passing above the support arms 92a and 92b and the terminals 62a and 62b connected to the lead portions 41a2 and 41b2 of the wires 41a and 41b passing below the support arms 92a and 92b are easily displaced and disposed along the longitudinal direction of the support arms 92a and 92b. Therefore, insulation between these terminals is easily secured.

### Second Embodiment

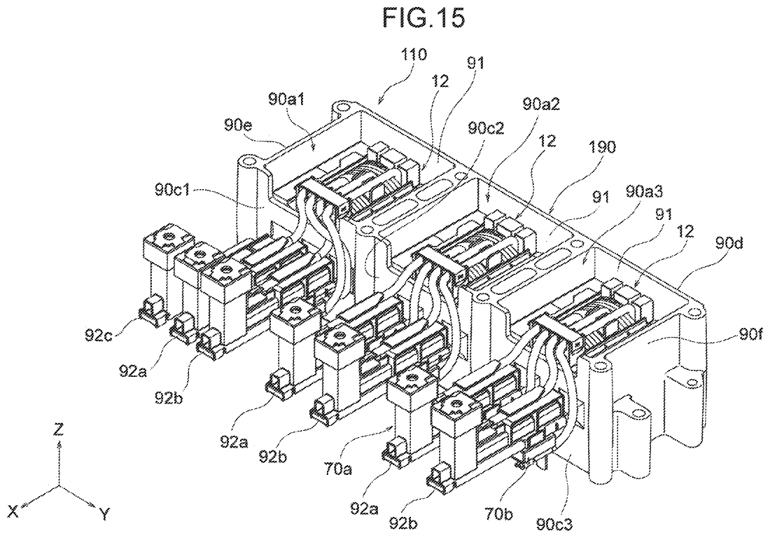

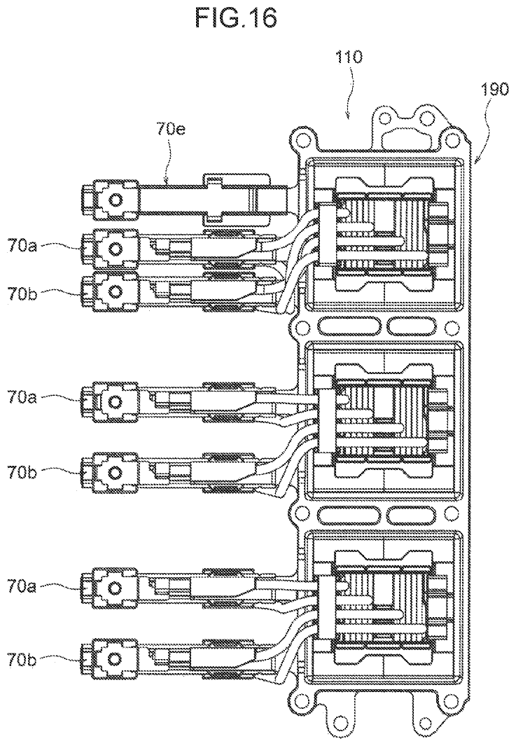

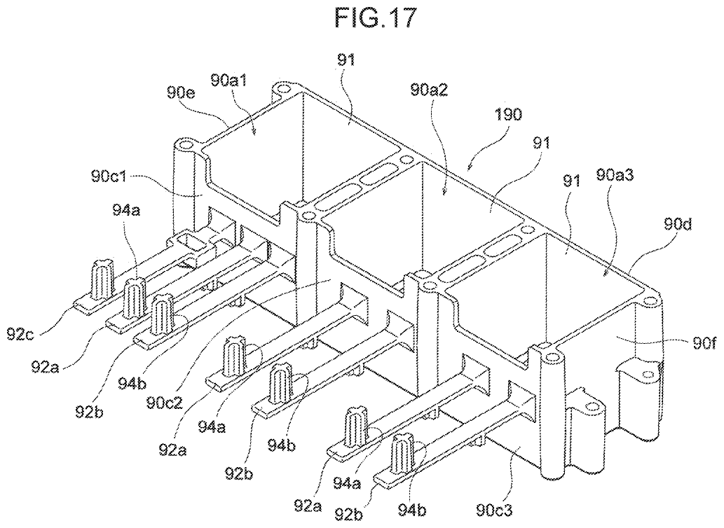

A coil device 110 according to the present embodiment illustrated in FIGS. 15 to 17 is similar to the coil device 10 according to the first embodiment except for the following matters, and exhibits similar actions and effects. The coil device 110 includes a case 190 including a plurality of accommodation portions 91 such that a plurality of upper openings 90a1 to 90a3 are provided along the Y axis and a plurality of dividing side walls 90c1 to 90c3 are formed along the Y axis. A device body 12 is accommodated in each of the accommodation portions 91.

In the present embodiment, support arms 92a and 92b are integrally formed with the respective dividing side walls 90c1 to 90c3. In the present embodiment, one dividing side wall 90c1 among the plurality of dividing side walls 90c1 to 90c3 is additionally provided with another support arm 92c, but the additional support arm 92c may not be provided. Similarly to the first embodiment, each of the support arms 92a and 92b includes terminal blocks 70a, 70b, 70c, and 70d. The support arm 92c also includes a terminal block similar to the terminal blocks 70a, 70b, 70c, and 70d described in the first embodiment.

Note that the present invention is not limited to the above-described embodiments, and various modifications can be made.

For example, the heat dissipation resin 100 is not limited to a potting resin, and may be another resin having excellent heat dissipation. The heat dissipation resin is configured of, for example, a silicone resin, a urethane resin, an epoxy resin, or the like that is soft even after injection, and the resin preferably has a longitudinal elastic modulus of 0.1 to 100 MPa, and a Shore A hardness of 100 or less, preferably 60 or less. Furthermore, in order to enhance heat dissipation, a filler having high thermal conductivity may be filled in the resin.

Furthermore, in the embodiments described above, as illustrated in FIG. 2, the bobbin 20 includes the separable first bobbin 20a and second bobbin 20b, and these bobbins 20a and 20b may be configured of a single integrally formed bobbin. Furthermore, the intermediate core 50c interposed between the separable first bobbin 20a and second bobbin 20b may be a split type or may be slidably insertable from the side of the single bobbin.

Moreover, in the above-described embodiments, the winding cores of the coil units 42a and 42b in the device body 12 are aligned with the X axis, but may be accommodated in the accommodation portion 91 of the case 90 or 190 so as to be aligned with the Y axis. Moreover, the coil device is not limited to the horizontal type, and may be a vertical type. That is, the device body 12 may be accommodated in the accommodation portion 91 of the case 90 or 190 such that the winding axis of the coil unit of the wire is substantially perpendicular to the bottom wall 90b of the case. The vertical coil device has an advantage that heat dissipation from the cores 50a and 50b to the case 90 or 190 is easily improved as compared with the horizontal coil device.

Moreover, in the above-described embodiments, the plurality of support arms 92a and 92b is provided on the same side surface of the case 90 or 190, but the plurality of support arms 92a and 92b may be provided on different side surfaces facing (or adjacent to) each other.

### EXPLANATIONS OF LETTERS OR NUMERALS

10, 110 coil device (transformer)
12 device body
20 bobbin
20a first bobbin
20b second bobbin
21a first winding core
21b second winding core
22a1, 22a2, 22b1, 22b2 flange
23a, 23b pedestal
24a, 24b protrusion
25a, 25b shaft hole
26a, 26b, 26c groove
27 groove cover
28a, 28b outer frame
30a, 30b inner frame
32, 34 bobbin cover
41a, 41b wire
41a1, 41a2, 41b1, 41b2 lead portion
42a, 42b coil unit
50a, 50b, 50c core
51a, 51b base
52a, 52b outer leg
53a, 53b middle leg
53a1, 53b1 distal end surface
61a, 61b, 62a, 62b terminal
63a, 63b, 64a, 64b external connection portion
65a, 65b connection hole
66a, 66b, 66c, 66d communication portion
67a, 67b, 68a, 68b joining portion
67a1, 67b1, 68a1, 68b1 folded piece
69a, 69b, 69c, 69d attachment claw
70a, 70b upper terminal block
70c, 70d lower terminal block
70e other terminal block
71c, 71d main plate portion
72a, 72b cover portion
72a1, 72b1 gripping piece
73a, 73b height adjusting portion
74a, 74b engagement piece
76a, 76b columnar member
77a, 77b lower hole
78a, 78b, 78c, 78d terminal holding surface
79a, 79b, 79c, 79d attachment groove
80a, 80b nut
82a, 82b upper hole
84a, 84b engagement piece
90, 190 case
90a, 90a1, 90a2, 90a3 upper opening
90b bottom wall
90c to 90f side wall
90c1 to 90c3 dividing wall
91 accommodation portion
92a, 92b, 92c support arm
94a, 94b upper protrusion
96a, 96b lower protrusion
100 heat dissipation resin
102, 103 substrate

What is claimed is:

1. A coil device comprising:
a device body including a bobbin and a coil unit of a wire wound around the bobbin;
a terminal block arranging a lead portion drawn out from a wire of the coil unit thereon; and
a case capable of accommodating the device body, wherein
the case includes a support arm extending outside the case, and
the terminal block is held by the support arm.

2. The coil device according to claim 1, wherein the support arm is formed integrally with the case.

3. The coil device according to claim 1, wherein the case is made of metal.

4. The coil device according to claim 1, wherein the device body is accommodated in the case such that a winding axis of the coil unit of the wire is substantially parallel to a bottom surface of the case.

5. The coil device according to claim 1, wherein a length of the support arm is longer than a width of the support arm.

6. The coil device according to claim 5, wherein a width of the support arm located at a connection portion with the case is larger than a width of a distal end portion of the support arm, and the support arm is integrated with the case in a cantilever shape.

7. The coil device according to claim 1, wherein the terminal block is configured of an insulating material, and includes a cover portion that covers at least an upper surface of the support arm along a direction in which the support arm extends.

8. The coil device according to claim 7, wherein the cover portion includes an engagement piece that guides the lead portion of the wire along the direction in which the support arm extends.

9. The coil device according to claim 1, wherein the support arm is disposed at an intermediate position between an upper end and a lower end of the case.

10. The coil device according to claim 9, wherein the support arm includes an upper protrusion extending upward from the support arm.

11. The coil device according to claim 9, wherein the support arm includes a lower protrusion extending downward from the support arm.

12. The coil device according to claim 10, wherein the terminal block includes a columnar member into which the upper protrusion is inserted, and a terminal to which a distal end of the lead portion is connected can be attached to an upper portion of the columnar member.

13. The coil device according to claim 11, wherein the terminal block includes a member with an upper hole into which the lower protrusion is inserted, and a terminal to which a distal end of the lead portion is connected can be attached to a lower portion of the member with the upper hole.

14. The coil device according to claim 9, wherein the lead portion drawn out from the wire of the coil unit comprising a pair of the lead portions, and one of the lead portions is disposed to pass through the terminal block located above the support arm, and an other lead portion is disposed to pass through the terminal block located below the support arm.

15. The coil device according to claim 1, wherein
the coil unit of the wire includes a coil unit of a pair of the wires,
the bobbin includes a first bobbin around which one of the wires is wound and a second bobbin around which an other wire is wound, the second bobbin is attached to the first bobbin, and
the support arm includes at least two support arms.
